(19) United States
(12) Patent Application Publication
(10) Pub. No.: US 2020/0406344 A1
(43) Pub. Date: Dec. 31, 2020

(54) MOLD-SHIFT DETECTION DEVICE FOR UPPER AND LOWER MOLDS AND MOLD-SHIFT DETECTION METHOD FOR UPPER AND LOWER MOLDS

(71) Applicant: SINTOKOGIO, LTD., Nagoya-shi, Aichi (JP)

(72) Inventors: Kazuya KOJIMA, Toyokawa-shi, Aichi (JP); Yasuaki ASAOKA, Toyokawa-shi, Aichi (JP); Hisashi HARADA, Toyokawa-shi, Aichi (JP); Takato ISHII, Toyokawa-shi, Aichi (JP)

(73) Assignee: SINTOKOGIO, LTD., Nagoya-shi, Aichi (JP)

(21) Appl. No.: 16/968,657

(22) PCT Filed: Dec. 6, 2018
(86) PCT No.: PCT/JP2018/044973

§ 371 Date: Aug. 10, 2020

(30) Foreign Application Priority Data
Feb. 13, 2018 (JP) 2018-023142

(51) Int. Cl. B22D 46/00; G01B 11/27

(52) U.S. Cl. CPC B22D 46/00; G01B 11/272

(57) ABSTRACT

A mold-shift detection device for upper and lower molds molded and assembled with each other by a flaskless molding machine, comprises: a first distance sensor measuring a distance by irradiating side surfaces of the upper and lower molds with light; a cylinder causing the first distance sensor to scan the side surfaces of the upper and lower molds; and a controller detecting a mold-shift between the upper and lower molds, based on a measurement result in a scan range.

### TECHNICAL FIELD

This disclosure relates to a mold-shift detection device for upper and lower molds, and a mold-shift detection method for upper and lower molds.

### BACKGROUND ART

Patent Document 1 discloses a device and a method for detecting a mold-shift between upper and lower molds before metal pouring, the molds having been molded by a flaskless molding machine and assembled with each other. This device detects the mold-shift between the upper and lower molds, on the basis of a measurement result of a laser displacement meter fixed or stopped laterally from the upper and lower molds.

### CITATION LIST

### Patent Document

Patent Document 1: International Publication No. WO 2017/122510

### SUMMARY OF INVENTION

### Technical Problem

The device and method described in Patent Document 1 have room for improvement, in view of increasing mold-shift detection accuracy. In this technical field, a device and a method that can accurately detect the mold-shift between upper and lower molds, have been required.

### Solution to Problem

An aspect of this disclosure is a mold-shift detection device for upper and lower molds molded and assembled with each other by a flaskless molding machine, comprising: at least one distance sensor configured to measure a distance by irradiating side surfaces of the upper and lower molds with light; a scanner configured to cause the at least one distance sensor to scan the side surfaces of the upper and lower molds; and a controller detecting a mold-shift between the upper and lower molds, based on a measurement result in a scan range scanned by the scanner.

In this mold-shift detection device, the side surfaces of the upper and lower molds are scanned by at least one distance sensor and the scanner. Accordingly, at least one distance sensor can measure the lateral shape of the upper mold, and the lateral shape of the lower mold. The mold-shift between the upper and lower molds is then detected by the controller on the basis of the lateral shape of the upper mold and the lateral shape of the lower mold. In this case, in comparison with a case of detecting the mold-shift on the basis of point data obtained with the distance sensors being fixed or stopped, the mold-shift detection device can detect the mold-shift even in a case where the upper and lower molds are inclined or in a case where the side surfaces of the molds are rough. Consequently, this mold-shift detection device can accurately detect the mold-shift between the upper and lower molds.

In one embodiment, the controller may detect the mold-shift between the upper and lower molds, based on the measurement result associating a height position of the at least one distance sensor and the distance obtained by measurement. In this case, the mold-shift detection device can grasp the lateral shapes of the upper and lower molds on a two-dimensional plane where the distance in the light emission direction by the distance sensor and the height direction are adopted as the coordinate axes.

In one embodiment, the controller may output an approximate line of the distance in the scan range through linear regression analysis in a coordinate system with the height position and the distance being adopted as coordinate axes, and detect the mold-shift between the upper and lower molds, based on the approximate line. In this case, the mold-shift detection device can suppress reduction in detection accuracy in a case where the side surfaces of the molds are rough or in a case where the upper and lower molds are inclined.

In one embodiment, the controller may detect the mold-shift between the upper and lower molds, based on a first intersection that is an intersection between the approximate line pertaining to the upper mold and a parting surface of the upper and lower molds, and a second intersection that is an intersection between the approximate line pertaining to the lower mold and the parting surface. In this case, for example, even when the bogie conveying the upper and lower molds is inclined, the mold-shift detection device can accurately grasp the ends of the upper and lower molds on the parting surface, and detect the mold-shift between upper and lower molds.

In one embodiment, the controller may detect the mold-shift between the upper and lower molds on the basis of the difference between the first intersection and the second intersection. In this case, the mold-shift detection device can easily detect the mold-shift between the upper and lower molds using one parameter that is the difference.

In one embodiment, the controller may store the measurement result in the scan range as a history in a storage. In this case, the mold-shift detection device can detect the mold-shift on the basis of an immediately previous difference, and can accumulate data for grasping a tendency.

In one embodiment, the controller may detect the mold-shift between the upper and lower molds, based on the comparison result between the difference and the immediately previous difference. In this case, the mold-shift detection device can detect the mold-shift, based on the difference from the immediately previous difference, instead of the predetermined threshold.

In one embodiment, the controller may detect the mold-shift between the upper and lower molds, based on the comparison result from the difference and a predetermined determination threshold.

In one embodiment, the controller may calculate respective central coordinates of the upper and lower molds and a skew angle between the upper and lower molds about a rotation axis that is in a vertical direction, based on a measurement result in the scan range, and detect the mold-shift between the upper and lower molds, based on the respective central coordinates of the upper and lower molds and the skew angle between the upper and lower molds. In this case, the mold-shift detection device can detect not only the deviation of the central coordinates of the upper and lower molds but also the deviation in the rotation direction.

In one embodiment, the controller may store respective central coordinates of the upper and lower molds and a skew angle between the upper and lower molds, as a history, in a storage. In this case, the mold-shift detection device can accumulate data for grasping the tendency of change of the central coordinates of the upper and lower molds, and the tendency of change of the skew angle between the upper and lower molds.

In one embodiment, the mold-shift detection device may further comprise a notifier notifying abnormality when the mold-shift is detected by the controller. In this case, the mold-shift detection device can notify an operator and the like of the abnormality.

In one embodiment, when the mold-shift is detected, the controller outputs an abnormal signal to another device. In this case, the mold-shift detection device can quickly notify the other device of the abnormality.

In one embodiment, the upper and lower molds may include first side surfaces, and second side surfaces, at least one distance sensor may include a first distance sensor irradiating the first side surfaces with light, a second distance sensor irradiating the first side surfaces with light, and a third distance sensor irradiating the second side surfaces with light, and the scanner may cause the first distance sensor and the second distance sensor to scan the first side surfaces, and may cause the third distance sensor to scan the second side surfaces. In this case, since the mold-shift can be detected based on the scanning result at a plurality of sites, the mold-shift detection device can further accurately detect the mold-shift between the upper and lower molds.

Another aspect of this disclosure is a mold-shift detection method for upper and lower molds molded and assembled with each other by a flaskless molding machine, comprising: a step of causing at least one distance sensor to measure a distance by irradiating side surfaces of the upper and lower molds with light; and a step of detecting a mold-shift between the upper and lower molds, based on a measurement result in a scan range.

This mold-shift detection method exerts the same advantageous effects as those of the mold-shift detection device described above.

### Advantageous Effects of Invention

According to the various aspects and modes of this disclosure, the device and method that can accurately detect the mold-shift between the upper and lower molds are provided.

### BRIEF DESCRIPTION OF DRAWINGS

FIG. 1 is a schematic plan view showing a mold-shift detection device according to an embodiment.

FIG. 2 is a diagram taken along A-A of FIG. 1.

FIG. 3 is a diagram taken along B-B of FIG. 1.

FIG. 4 is a schematic view for illustrating measurement at a measurement start height.

FIG. 5 is a schematic view for illustrating measurement at a measurement end height.

FIG. 6 is a schematic view illustrating a skew angle.

FIG. 7 is a flowchart pertaining to a measurement process in the mold-shift detection method.

FIG. 8 is a graph showing measurement results and approximate lines.

FIG. 9 illustrates adverse effects exerted on mold-shift detection by an inclination of upper and lower molds.

### DESCRIPTION OF EMBODIMENTS

Hereinafter, referring to the drawings, exemplary embodiments are described. Note that in the following description, the same or equivalent elements are assigned the same symbols, and redundant description is not repeated.

(Configuration of mold-shift detection device)

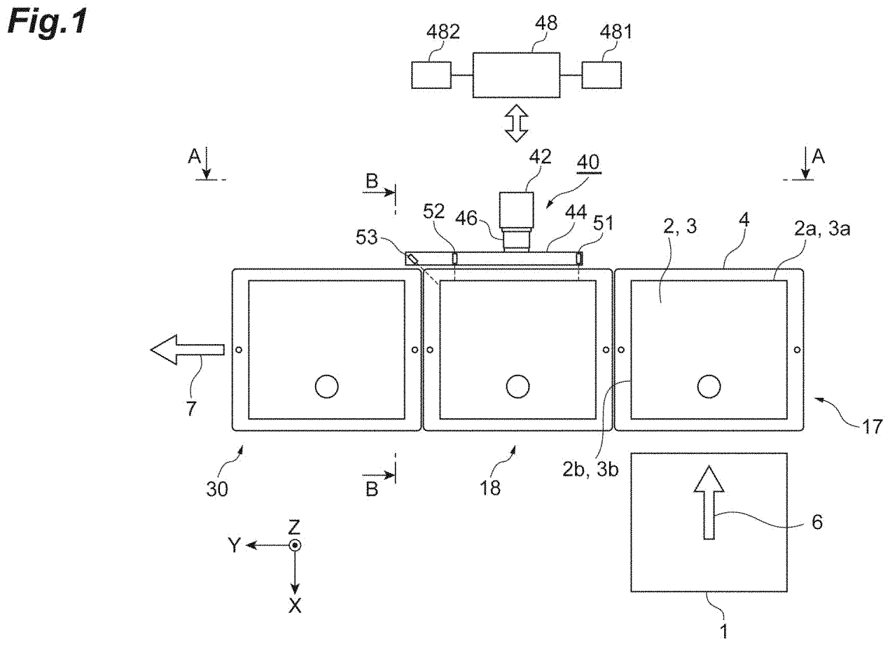

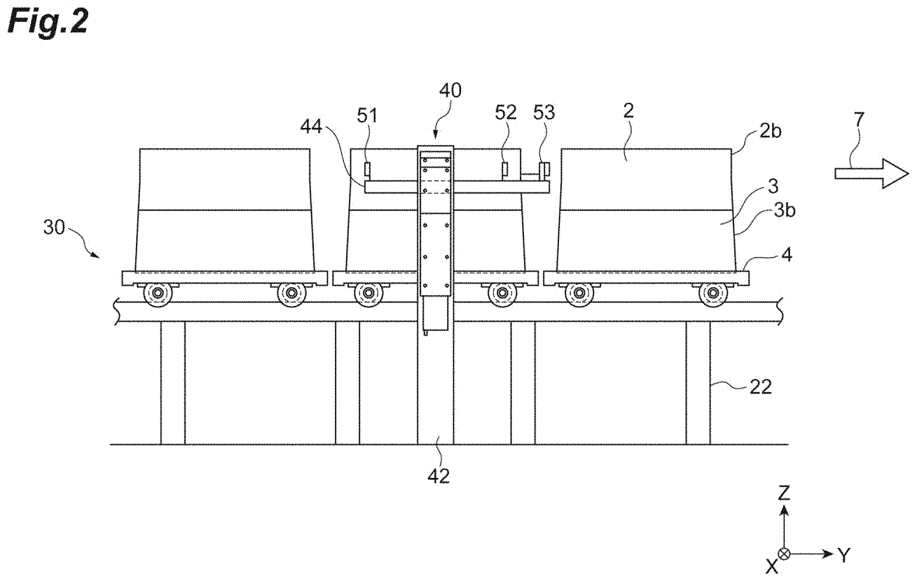

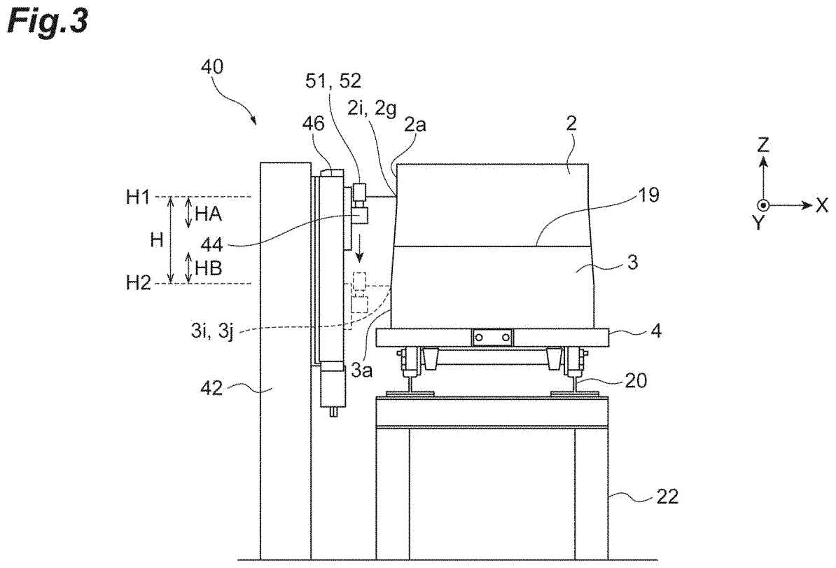

FIG. 1 is a schematic plan view showing a mold-shift detection device according to an embodiment. FIG. 2 is a diagram taken along A-A of FIG. 1. FIG. 3 is a diagram taken along B-B of FIG. 1. In the diagrams, the XY direction is the horizontal direction, and the Z direction is the vertical direction.

A flaskless molding machine 1 shown in FIG. 1 is a molding machine of a type which makes upper and lower molds using molding sand (green molding sand in this embodiment), then assembles the upper and lower molds, and subsequently extracts the upper and lower molds from upper and lower molds, and in which the upper and lower molds are discharged from the molding machine in a state of being only themselves.

The upper and lower molds are a collective term of an upper mold 2 and a lower mold 3. The cross sections of the upper and lower molds are substantially rectangular shapes, for example. The upper and lower molds include a first side surface, and a second side surface. As shown in FIG. 1, the first side surface comprises a first side surface 2a of the upper mold 2, and a first side surface 3a of the lower mold 3. The second side surface comprises a second side surface 2b of the upper mold 2, and a second side surface 3b of the lower mold 3.

At a position adjacent to the flaskless molding machine 1, a mold carry-in station 17 is provided, and a surface plate bogie 4 is arranged. In a state where the upper mold 2 and the lower mold 3 are assembled with each other, the flaskless molding machine 1 discharges the molds in the direction of an arrow 6 (the negative X-axis direction in the diagram) by a cylinder and the like, and are mounted on the surface plate bogie 4.

As shown in FIGS. 1 to 3, the upper and lower molds mounted on the surface plate bogie 4 are intermittently conveyed in a state of a continuous mold group, on a one-pitch (for one mold unit) basis, in the direction of an arrow 7 (the positive Y-axis direction in the diagram) by conveyance means, not shown, (for example, a pusher device, and a cushion device). The direction of the arrow 7 is the conveyance direction of the assembled upper and lower molds. The surface plate bogie 4 travels on rails 20 that are supported by frames 22 and serve as a conveyance path of the upper and lower molds. Accordingly, the surface plate bogie 4 sequentially moves to the mold carry-in station 17, a mold-shift detection station 18 and a conveyance path 30, thus moving to a device that performs a subsequent step.

As for the mold-shift detection station 18, a mold-shift detection device 40 for upper and lower molds is arranged laterally to the rails 20. The mold-shift detection device 40 for upper and lower molds is a device that detects a mold-shift between the upper mold 2 and the lower mold 3 which are assembled. The mold-shift detection device 40 includes at least one distance sensor. In the diagram, the mold-shift detection device 40 includes, for example, a first distance sensor 51, a second distance sensor 52, and a third distance sensor 53.

The first distance sensor 51 measures the distance by irradiating side surfaces of the upper and lower molds with light. For example, the first distance sensor 51 measures the distance by what is called a triangulation scheme. The first distance sensor 51 irradiates the side surfaces of the upper and lower molds with a laser beam, condenses a part of light reflected in a scattering manner at the side surfaces of the upper and lower molds by using lens, and causes an imaging element to receive the light. When the laser-irradiated position (depth direction) is changed, the light receiving position on the imaging element is changed. Accordingly, based on the relationship between the light receiving position and the irradiated position, the distance to the side surfaces of the upper and lower molds can be measured. The second distance sensor 52 and the third distance sensor 53 can have the same configuration as the first distance sensor 51.

The first distance sensor 51, the second distance sensor 52 and the third distance sensor 53 are provided on an up-and-down frame 44 extending in the Y-axis direction. The up-and-down frame 44 is a beam having a length of substantially one frame of the upper and lower molds in the Y-axis direction.

The first distance sensor 51 and the second distance sensor 52 are provided on the up-and-down frame 44 such that the light emission directions therefrom face the first side surfaces of the upper and lower molds (the first side surface 2a of the upper mold 2, and the first side surface 3a of the lower mold 3). The first side surfaces of the upper and lower molds form planes parallel to the conveyance direction during conveyance. That is, the first distance sensor 51 and the second distance sensor 52 may face a direction (X-axis direction) perpendicular to the direction of the up-and-down frame 44 (Y-axis direction). The first distance sensor 51 is provided close to the rear end of the up-and-down frame 44 in the conveyance direction of the upper and lower molds, and measures the distance to the first side surfaces of the upper and lower molds. The second distance sensor 52 is provided close to the front end of the up-and-down frame 44 in the conveyance direction of the upper and lower molds, and measures the distance to the first side surfaces of the upper and lower molds.

The third distance sensor 53 is provided on the up-and-down frame 44 such that the light emission direction therefrom faces the second side surfaces of the upper and lower molds (the second side surface 2b of the upper mold 2, and the second side surface 3b of the lower mold 3). The second side surfaces of the upper and lower molds form planes perpendicular to the conveyance direction during conveyance. Accordingly, unlike the first distance sensor 51 and the second distance sensor 52, the third distance sensor 53 is oriented obliquely from the up-and-down frame 44.

As described above, the first distance sensor 51, the second distance sensor 52 and the third distance sensor 53 are arranged substantially in one line on the up-and-down frame 44, and can measure the distances to three points on a plane (not on a line), that is, the positions. The mold-shift detection device 40 does not impede conveyance of the upper and lower molds to be conveyed.

The up-and-down frame 44 is supported by the support frame 42 provided vertically from the base, in a manner capable of being raised or lowered.

The mold-shift detection device 40 includes a cylinder 46 (an example of a scanner) that allows the first distance sensor 51, the second distance sensor 52 and the third distance sensor 53 to scan the side surfaces of the upper and lower molds. The cylinder 46 may be any cylinder, such as of electric, oil-hydraulic, hydraulic, or air pressure type. The cylinder 46 is an actuator that raises and lowers the up-and-down frame 44, and is supported by the support frame 42. By driving the cylinder 46, the first distance sensor 51, the second distance sensor 52 and the third distance sensor 53 provided on the up-and-down frame 44 are collectively raised and lowered. As described above, the cylinder 46 simultaneously scans the side surfaces of the upper and lower molds in the vertical direction by raising and lowering the first distance sensor 51, the second distance sensor 52 and the third distance sensor 53.

The cylinder 46 causes the first distance sensor 51, the second distance sensor 52 and the third distance sensor 53 to scan a predetermined scan range while moving the sensors across a parting surface 19 of the upper and lower molds. The parting surface 19 is a joining plane of the upper mold 2 and the lower mold 3. The height from an upper surface of the surface plate bogie 4 to the parting surface 19 is the same as the height of the lower mold 3. The height of the lower mold 3 is measured every time by measurement means (for example, an encoder), not shown, in the flaskless molding machine 1. Accordingly, the height of the parting surface 19 described above is grasped every time.

The scan range of each sensor by the cylinder 46 can be appropriately set on the side surfaces of the upper and lower molds. For example, as shown in FIG. 3, the scan range H is a range from the measurement start height to the measurement end height in the vertical direction, and may be set to include the height of the parting surface 19. In FIG. 3, the range from the measurement start height H1 to the measurement end height H2 is the scan range H. The scan range may be set individually for each of the upper and lower molds by a controller 48, described later. As shown in FIG. 3, for example, a first scan range HA for the upper mold 2, and a second investigation range HB for the lower mold 3 may be set. In this case, the scan ranges do not include the height of the parting surface 19. Alternatively, the scan ranges may be ranges preset based on an assumed height of the parting surface 19. For example, the scan ranges are set in such a way as to be ±100 mm with reference to the parting surface 19. Hereinafter, the scan range is described with an example of the scan range H from the measurement start height H1 to the measurement end height H2. However, the range is not limited thereto.

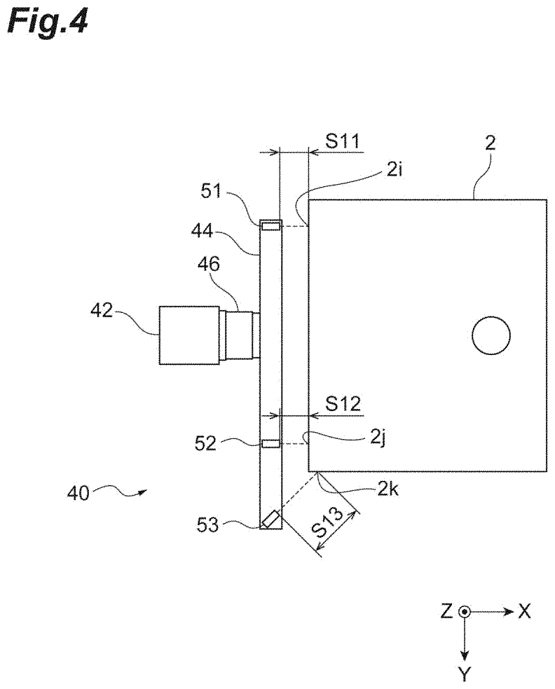

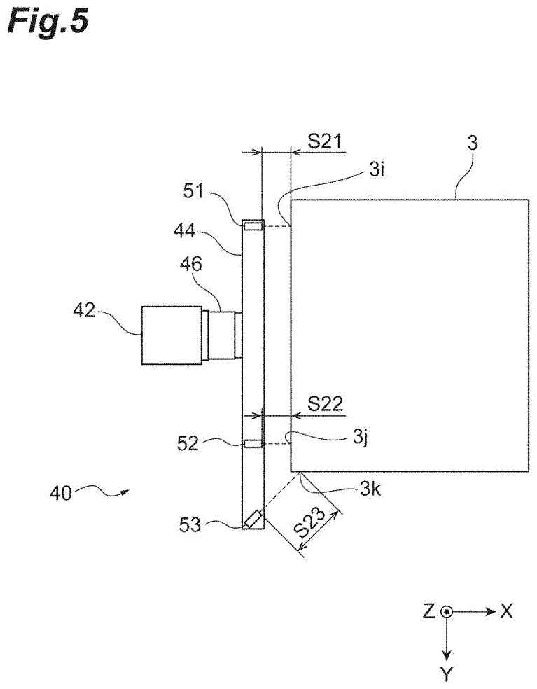

FIG. 4 is a schematic view for illustrating measurement at the measurement start height H1. FIG. 5 is a schematic view for illustrating measurement at the measurement end height H2. As shown in FIGS. 3 and 4, at the measurement start height H1, the distance S11 to a measurement point 2i on the first side surface 2a of the upper mold 2 is measured by the first distance sensor 51, the distance S12 to a measurement point 2j on the first side surface 2a of the upper mold 2 is measured by the second distance sensor 52, and the distance S13 to a measurement point 2k on the second side surface 2b of the upper mold 2 is measured by the third distance sensor 53. As shown in FIGS. 3 and 5, at the measurement end height H2, the distance S21 to a measurement point 3i on the first side surface 3a of the lower mold 3 is measured by the first distance sensor 51, the distance S22 to a measurement point 3j on the first side surface 3a of the lower mold 3 is measured by the second distance sensor 52, and the distance S23 to a measurement point 3k on the second side surface 3b of the lower mold 3 is measured by the third distance sensor 53.

As described above, the first distance sensor 51 linearly scans the scan range H, thus scanning from the measurement point 2i to the measurement point 3i. The second distance sensor 52 linearly scans the scan range H, thus scanning from the measurement point 2j to the measurement point 3j. The third distance sensor 53 linearly scans the scan range H, thus scanning from the measurement point 2k to the measurement point 3k. That is, the first distance sensor 51, the second distance sensor 52 and the third distance sensor 53 linearly scan different points on the side surfaces of the upper and lower molds in the vertical direction.

The mold-shift detection device 40 includes the controller 48. The controller 48 is hardware that entirely integrates the mold-shift detection process. The controller 48 is configured to be a typical computer that includes a processing unit (CPU etc.), a storage unit (ROM, RAM, HDD, etc.), a user interface, and the like.

The controller 48 is connected to the cylinder 46, and outputs a signal to the cylinder 46 to control driving of the cylinder 46. The controller 48 obtains the height positions of the first distance sensor 51, the second distance sensor 52 and the third distance sensor 53 on the basis of an output signal to the cylinder 46 or a position detection sensor (an encoder or the like), not shown. The controller 48 is connected to the first distance sensor 51, the second distance sensor 52 and the third distance sensor 53, and obtains the distances obtained by the respective distance sensors.

The controller 48 associates the height position with the distance for each distance sensor, and stores them as a measurement result. The measurement result is a set of measurement values. The measurement value is a value where the height position and the distance are associated with each other. The controller 48 may successively store the measurement results of each distance sensor, in the storage unit described above, or may integrate the measurement results of each distance sensor in the scan range H as a result for one time and store it in a storage 481.

The controller 48 detects mold-shift between the upper and lower molds on the basis of the measurement result in the scan range H where scanning is performed by the cylinder 46. The measurement result in the scan range H is a linearly scanned result, and accordingly serves as data in which the lateral shapes of the upper and lower molds are mirrored. In a coordinate system where the height position and the distance are adopted as coordinate axes, the controller 48 outputs an approximate line of the distance in the scan range H through linear regression analysis, and detects the mold-shift between upper and lower molds, on the basis of the approximate line. The approximate line is one line obtained by regression analysis based on measurement data in a certain range.

As a specific example using the approximate line, the controller 48 calculates a first intersection that is an intersection between the approximate line pertaining to the upper mold 2 and the parting surface 19, and a second intersection that is an intersection between the approximate line pertaining to the lower mold 3 and the parting surface 19. The first intersection corresponds to the lower end of the upper mold 2 on the parting surface 19. The second intersection corresponds to the upper end of the lower mold 3 on the parting surface 19. The controller 48 detects the mold-shift between the upper and lower molds, from the position relationship between the first intersection and the second intersection.

For example, the controller 48 detects the mold-shift between the upper and lower molds on the basis of the difference between the first intersection and the second intersection. When the difference is equal to or larger than a predetermined threshold, the controller 48 determines that the mold-shift between the upper and lower molds occurs. The predetermined threshold can be appropriately set on the basis of an allowable amount of shift. Alternatively, the controller 48 detects the mold-shift between the upper and lower molds on the basis of the comparison result between the difference and the immediately previous difference. The immediately previous difference is a difference derived from the last measurement result. The last measurement result is a previously obtained measurement result, and may be only an immediately previous measurement result, or all the measurement results obtained in the past. The controller 48 may store the processed difference in the storage 481 and use it for determination next time or thereafter, or may process the immediately previous difference from the last measurement result on every determination. When the difference between that difference and the immediately previous difference is equal to or larger than a predetermined value, the controller 48 determines that the mold-shift between the upper and lower molds occurs.

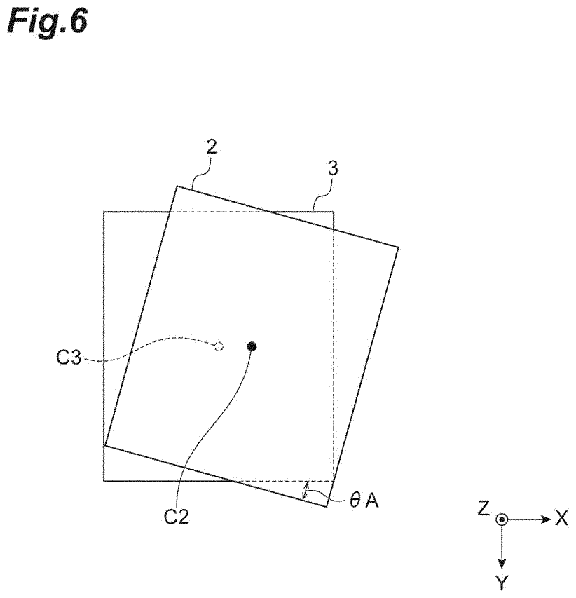

The controller 48 may calculate the respective central coordinates of the upper and lower molds and a skew angle between the upper and lower molds about a rotation axis that is in the vertical direction, on the basis of the measurement result in the scan range H. FIG. 6 is a schematic view illustrating the skew angle. As shown in FIG. 6, the skew angle θA is an angle indicating a relative rotational skew between the upper mold 2 and the lower mold 3 in a case where the vertical direction is adopted as the rotation axis. The shapes of the upper mold 2 and the lower mold 3 made by the flaskless molding machine 1 have already been known. The first distance sensor 51, the second distance sensor 52 and the third distance sensor 53 are disposed on the identical horizontal plane. Accordingly, the controller 48 can obtain the central coordinates C2 and C3 of the upper mold 2 and the lower mold 3, and the skew angle θA between the upper mold 2 and the lower mold 3, from the measurement results of the three sensors at the predetermined height.

The controller 48 may detect the mold-shift between the upper and lower molds, on the basis of the central coordinates C2 and C3 of the upper and lower molds and the skew angle θA between the upper and lower molds. The controller 48 may compare the central coordinates C2 and C3 with each other, and detect the mold-shift. For example, the controller 48 calculates the distance between the central coordinates C2 and C3, and determines that the mold-shift occurs in the horizontal direction in the XY plane, when the distance is equal to or larger than a predetermined distance. For example, when the skew angle θA is equal to or larger than a predetermined angle, the controller 48 determines that the mold-shift occurs in the rotation direction about the rotation axis that is the Z axis. That is, the controller 48 can detect both the mold-shift in the horizontal direction in the XY plane and the mold-shift in the rotation direction about the rotation axis that is the Z axis, using the respective central coordinates C2 and C3 of the upper and lower molds and the skew angle θA between the upper and lower molds. The controller 48 may store the respective central coordinates C2 and C3 of the upper and lower molds and the skew angle θA between the upper and lower molds, as a history, in the storage 481.

The mold-shift detection device 40 further includes a notifier 482 that notifies abnormality when the mold-shift is detected by the controller 48. The notifier 482 is a device that is connected to the controller 48, and notifies an operator and the like of information by outputting sound or video. For example, the notifier 482 is a speaker, a display and the like. When detecting the mold-shift, the controller 48 outputs an abnormal signal to the notifier 482. Upon receipt of the abnormal signal, the notifier 482 issues a notification.

Upon detection of the mold-shift, the controller 48 may output the abnormal signal to other devices. The other devices are the flaskless molding machine 1, the conveyance path 30, a pouring machine (not shown) and the like. The abnormal signal is information indicating that the mold-shift is detected. When the flaskless molding machine 1 obtains the abnormal signal, the flaskless molding machine 1 may adjust device parameters such that mold-shift does not occur. For example, the flaskless molding machine 1 may adjust the speed of extruding the upper and lower molds to the mold carry-in station 17. The abnormal signal may include the mold-shift direction. In this case, the flaskless molding machine 1 can determine whether the extrusion of the upper and lower molds is a cause of the mold-shift or not, from the mold-shift direction. Upon obtainment of the abnormal signal, the conveyance path 30 may stop conveyance of the upper and lower molds to the pouring machine, or adjust the assembly of the upper and lower molds. Upon obtainment of the abnormal signal, the pouring machine may skip or stop pouring to the upper and lower molds where mold-shift occurs. Alternatively, the abnormal signal may be output to devices connected to shock sensors respectively arranged at points on the conveyance path. In this case, the devices may identify a mold-shift causing site on the basis of the mold-shift direction and the respective shock sensors.

(Mold-Shift Detection Method)

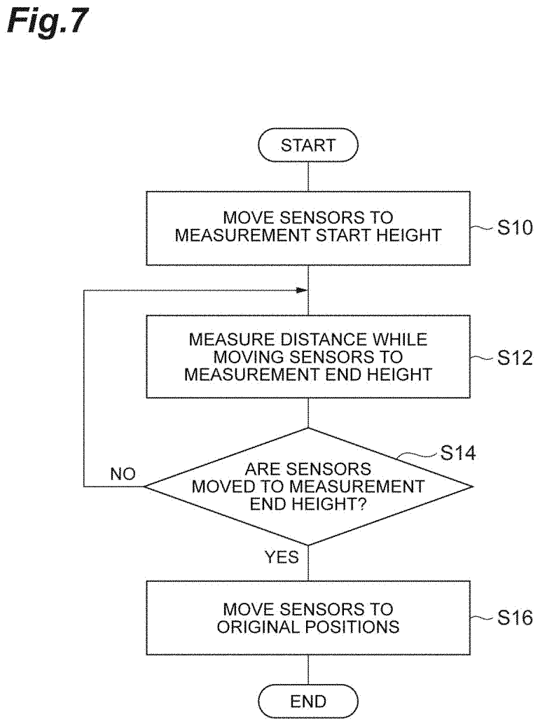

The mold-shift detection method may include a step of scanning a distance sensor, and a step of detecting the mold-shift. First, the step of scanning the distance sensor is described. FIG. 7 is a flowchart pertaining to a measurement process in the mold-shift detection method. The flowchart shown in FIG. 7 is executed by the controller 48 of the mold-shift detection device 40. For example, the flowchart shown in FIG. 7 is executed at timing when the upper and lower molds that are to be intermittently conveyed are conveyed to the mold-shift detection station 18, that is, when the upper and lower molds are stopped at a predetermined position with respect to the mold-shift detection device 40.

As shown in FIG. 7, in a moving process (S10), the controller 48 moves the distance sensors from the original positions (the original position of the cylinder 46) of the distance sensors to the measurement start height H1. The controller 48 outputs a control signal to the cylinder 46, and moves the distance sensors to the measurement start height H1.

Subsequently, in a data measurement process (S12), the controller 48 measures the distance while moving the distance sensors to the measurement end height H2. In a finish determination process (S14), the controller 48 determines whether the distance sensors are moved to the measurement end height H2 or not. When it is determined that the distance sensors are not moved to the measurement end height H2 (S14: NO), the controller 48 continues the data measurement process (S12). When it is determined that the distance sensors are moved to the measurement end height H2 (S14: YES), the controller 48 moves the distance sensors to the original positions (the original position of the cylinder 46) in a finish process (S16). After the finish process (S16) is completed, the flowchart shown in FIG. 7 is finished. After the flowchart shown in FIG. 7 is finished, measurement results for one time are obtained.

Subsequently, a step of detecting the mold-shift is described. The controller 48 determines the mold-shift on the basis of the measurement results obtained by executing the flowchart shown in FIG. 7. The controller 48 may determine the mold-shift on the basis of the obtained data even during execution of the flowchart shown in FIG. 7, or may determine the mold-shift after obtainment of the entire data in the scan range H is completed.

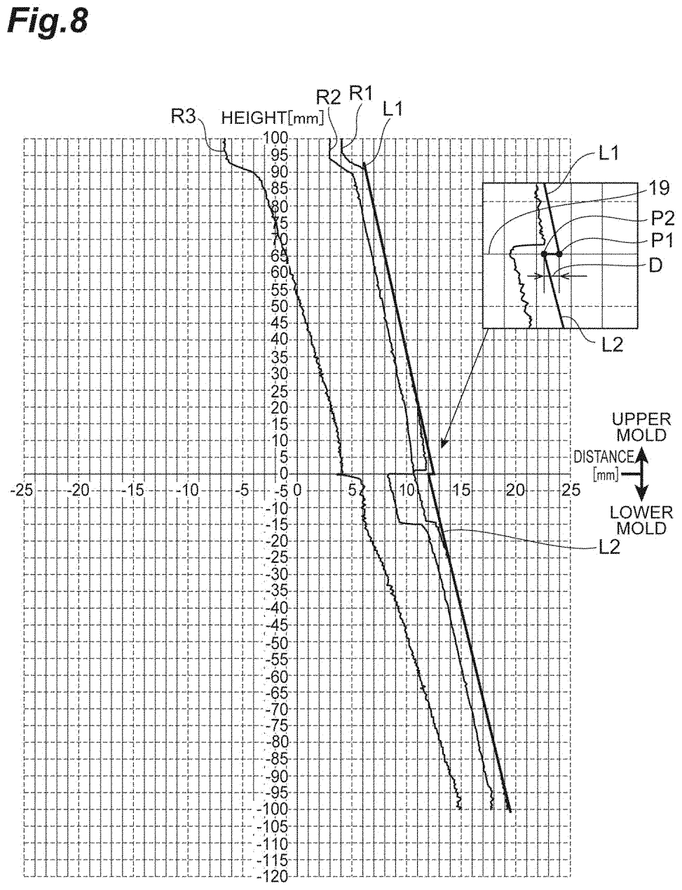

FIG. 8 is a graph indicating the measurement results and approximate lines. In FIG. 8, the abscissa axis indicates the distance, and the ordinate axis indicates the measurement height. In FIG. 8, the parting surface 19 is normalized to be 0 mm of height. In FIG. 8, a data item R1 that is a measurement result of the first distance sensor 51, a data item R2 that is a measurement result of the second distance sensor 52, and a data item R3 that is a measurement result of the third distance sensor, are indicated. To determine the mold-shift in the data item R1, the controller 48 approximates the data item on the upper mold 2 and obtains an approximate line L1, and approximates the data item on the lower mold 3 and obtains an approximate line L2. Subsequently, the controller 48 calculates a first intersection P1 that is the intersection between the approximate line L1 and the parting surface 19, and a second intersection P2 that is the intersection between the approximate line L2 and the parting surface 19. The controller 48 then calculates the difference D between the first intersection P1 and the second intersection P2. The controller 48 compares the difference D and the immediately previous difference with each other. When the difference is equal to or less than a predetermined value, the controller 48 determines that the mold-shift does not occur. When the difference exceeds the predetermined value, the controller 48 determines that the mold-shift occurs. Additionally, the controller 48 can obtain the central coordinates of the upper and lower molds and the skew angle between the upper and lower molds at every height, using the data items R1, R2 and R3. Furthermore, the mold-shift can be determined from the central coordinates and the skew angle.

The determination result of the mold-shift is transmitted to a control unit of the flaskless molding machine 1, the conveyance path 30, or the pouring machine (not shown), for example. After the mold-shift detection in the mold-shift detection device 40 is finished, the upper and lower molds are intermittently conveyed again. Subsequently, before metal pouring, the upper and lower molds are covered with a jacket (not shown), and a weight is mounted on the upper surface of the upper mold 2. Subsequently, metal is poured from the pouring machine (not shown).

### Overview of Embodiments

In the mold-shift detection device 40 according to this embodiment, the side surfaces of the upper and lower molds are scanned by at least the first distance sensor 51 and the cylinder 46. Accordingly, at least the first distance sensor 51 can measure the lateral shape of the upper mold 2, and the lateral shape of the lower mold 3. The mold-shift between the upper and lower molds is then detected by the controller 48 on the basis of the lateral shape of the upper mold 2 and the lateral shape of the lower mold 3. Consequently, in comparison with a case of detecting the mold-shift on the basis of point data obtained with the distance sensors being fixed or stopped, the mold-shift detection device 40 can detect the mold-shift even when the upper and lower molds are inclined or when the side surfaces of the molds are rough, for example. Consequently, this mold-shift detection device can accurately detect the mold-shift between the upper and lower molds.

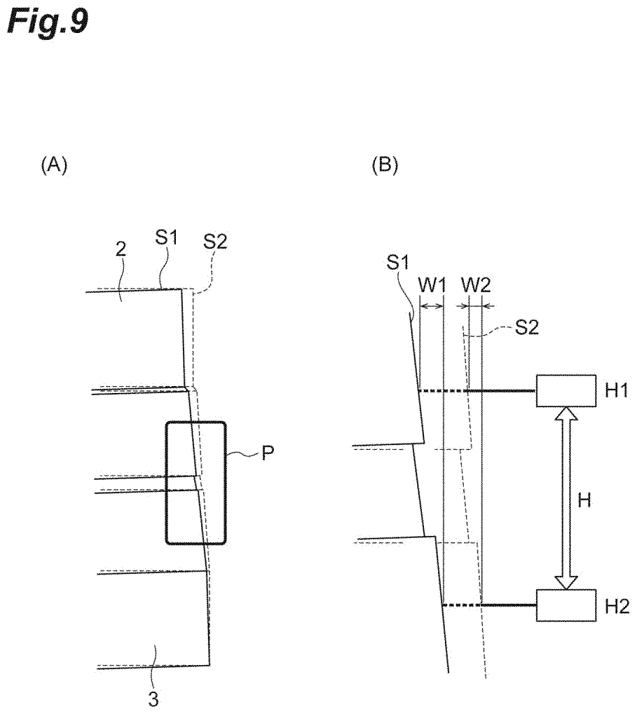

To illustrate effects by linear scanning, an overview in a case of performing one measurement for the upper mold 2 (measurement with the fixed height) and one measurement for the lower mold 3 (measurement with the fixed height) is described. In the case where the height for measurement is fixed, there is a possibility that the mold-shift cannot be correctly detected when the upper and lower molds are inclined. FIG. 9 illustrates adverse effects exerted on mold-shift detection by an inclination of the upper and lower molds. In FIG. 9(A), the inclined upper and lower molds (state S1) are indicated by solid lines, the upper and lower molds that are not inclined (state S2) are indicated by broken lines. When the surface plate bogie 4 is inclined from the horizontal direction, the upper and lower molds are also in an inclined state (state S1).

FIG. 9(B) is an enlarged diagram of a part P in FIG. 9(A). As shown in FIG. 9(B), when the upper and lower molds are not inclined (state S2), the difference between the measurement distance at the measurement start height H1 and the measurement distance at the measurement end height H2 is W2. On the other hand, when the upper and lower molds are inclined (state S1), the difference between the measurement distance at the measurement start height H1 and the measurement distance at the measurement end height H2 is W1, which is longer than W2. As described above, the measurement distance is changed owing to the inclination of the upper and lower molds. Accordingly, even when the mold-shift does not occur in actuality, it may be erroneously detected that the mold-shift occurs by the inclination of the upper and lower molds.

On the contrary, according to the controller 48, the mold-shift between the upper and lower molds is detected on the basis of the lateral shape of the upper mold 2 and the lateral shape of the lower mold 3. The inclination of the upper and lower molds affects the inclination angles of the side surfaces, but does not affect the lateral shape. Consequently, this mold-shift detection device 40 can accurately detect the mold-shift between the upper and lower molds.

By obtaining the measurement result associating the height and the distance with each other, the mold-shift detection device 40 can grasp the lateral shapes of the upper and lower molds on a two-dimensional plane where the distance in the light emission direction by the distance sensor and the height direction are adopted as the coordinate axes.

The mold-shift detection device 40 outputs the approximate line of the distance in the scan range by linear regression analysis in the coordinate system where the height position and the distance are adopted as the coordinate axes, and detects the mold-shift between the upper and lower molds on the basis of the approximate line, thereby allowing reduction in detection accuracy to be suppressed in the case where the side surfaces of the molds are rough or in the case where the upper and lower molds are inclined.

Based on the first intersection P1 that is the intersection between the approximate line L1 pertaining to the upper mold 2 and the parting surface 19 of the upper and lower molds and the second intersection P2 that is the intersection between the approximate line L2 pertaining to the lower mold 3 and the parting surface 19 of the upper and lower molds, the mold-shift detection device 40 detects the mold-shift between the upper and lower molds, which can accurately grasp the ends of the upper and lower molds on the parting surface 19 and detect the mold-shift between the upper and lower molds even when the surface plate bogie 4 is inclined from the horizontal direction.

The mold-shift detection device 40 detects the mold-shift between upper and lower molds on the basis of the difference between the first intersection P1 and the second intersection P2, which can easily detect the mold-shift between the upper and lower molds using one parameter, which is the difference.

The mold-shift detection device 40 stores the measurement result in the scan range, as a history, in the storage 481, which can detect the mold-shift on the basis of the immediately previous difference, and can accumulate data for grasping the tendency.

Based on the comparison result between the difference and the immediately previous difference, the mold-shift detection device 40 detects the mold-shift between the upper and lower molds, which can detect the mold-shift on the basis of the difference from the immediately previous difference, instead of a predetermined determination threshold.

The mold-shift detection device 40 calculates respective central coordinates of the upper and lower molds and the skew angle between the upper and lower molds about the rotation axis that is in the vertical direction, on the basis of the measurement result in the scan range H, and can detect the mold-shift between the upper and lower molds on the basis of the central coordinates of the upper and lower molds and the skew angle between the upper and lower molds. Additionally, by storing in the storage 481 as the history, data for grasping the tendency of change of the central coordinates of the upper and lower molds, and the tendency of change of the skew angle between the upper and lower molds, can be accumulated.

The mold-shift detection device 40 includes the notifier 482 that notifies abnormality when the mold-shift is detected by the controller 48, thereby allowing the operator or the like to be notified of the abnormality. Upon detection of the mold-shift, the mold-shift detection device 40 can quickly notify the other devices of abnormality, and allow the other devices to take measures for avoiding the abnormality, by outputting an abnormal signal to the other devices.

The mold-shift detection device 40 includes three distance sensors, which can further accurately detect the mold-shift between the upper and lower molds.

The embodiments described above can be implemented in various modes obtained by applying various changes and modifications based on the knowledge of those skilled in the art.

For example, when the mold-shift is determined as a result of mold-shift detection, a factor of causing the mold-shift may be identified from the situations of the mold-shift and be displayed. For example, when the upper mold 2 deviates rearward from the lower mold 3 in the mold extrusion direction (the direction of the arrow 6 in FIG. 1) in the flaskless molding machine 1, a too high initial speed at the time of extruding the lower mold 3 by a mold extrusion device (not shown) can be considered a factor. Additionally, when the upper mold 2 deviates rearward from the lower mold 3 in the traveling direction of the conveyance path 30 (the direction of the arrow 7 in FIG. 1), a too high initial speed when the pusher device (not shown) pushes the surface plate bogie 4 can be considered a factor. The factor can thus be identified based on the direction of the deviation between the upper mold 2 and the lower mold 3. Accordingly, by displaying the identified factor, the operator can easily recognize the details to be repaired, and the cause of causing the mold-shift can be easily resolved. Note that the identified factor of causing the mold-shift may be displayed on a display panel of the mold-shift detection device 40, a certain display panel, or a control unit of another device.

Additionally, when the mold-shift is determined as a result of mold-shift detection, a factor of causing the mold-shift may be identified from the situations of the mold-shift, and the operation condition of facilities to be a factor of the mold-shift can be modified. For example, when the upper mold 2 deviates rearward from the lower mold 3 in the mold extrusion direction (the direction of the arrow 6 in FIG. 1) in the flaskless molding machine 1, a too high initial speed at the time of extruding the lower mold 3 by a mold extrusion device (not shown) can be considered a factor. In this case, as the operation condition of facilities to be a factor, the initial speed of the mold extrusion device is modified. Specifically, setting of the initial speed is automatically or manually modified such that the initial speed of the mold extrusion device is low. As described above, occurrence of the mold-shift in the next cycle and thereafter is resolved. Additionally, when the upper mold 2 deviates rearward from the lower mold 3 in the traveling direction of the conveyance path 30 (the direction of the arrow 7 in FIG. 1), a too high initial speed when the pusher device (not shown) pushes the surface plate bogie 4 can be considered a factor. In this case, as the operation condition of facilities to be a factor, the initial speed of the pusher device is modified. Specifically, setting of the initial speed is automatically or manually modified such that the initial speed of the pusher device is low. As described above, occurrence of the mold-shift in the next cycle and thereafter is resolved.

Additionally, if it is not determined to be a mold-shift as a result of mold-shift detection, it is preferable to store, as data, the fact that the mold-shift is not caused by the flaskless molding machine 1 or the conveyance path 30 for conveying the upper and lower molds from the flaskless molding machine 1 to the pouring position. By storing the data as described above, it can be confirmed that there is not a problem of a mold-shift during molding even in case a defect is found in a product, thus facilitating identification of the cause. Note that the data is stored in the controller 48 or a control unit of another device.

Additionally, even if the amount of mold-shift between the upper mold 2 and the lower mold 3 calculated by the controller 48 is in a preset allowable range but exceeds a warning range set to be smaller than the allowable range, it is preferable to display presence of a symptom of a mold-shift. When the presence of a symptom is displayed, the operation condition of facilities to be a factor is modified before the upper and lower molds becomes defective owing to a mold-shift, and the waste due to the defect can be prevented. Note that presence of a symptom of a mold-shift may be displayed on a display panel of the mold-shift detection device 40, a certain display panel, or a control unit of another device.

The number of distance sensors is not limited to three, and may be at least one. Scanning by the distance sensors are from the top to the bottom, but may be inverted therefrom. The actuator is not limited to the cylinder 46, and may be other publicly known means, such as a trapezoidal thread or a pantograph. Alternatively, the support frame 42 may be fixed to the frame 22, without being provided vertically from the base.

The controller 48 may be provided as dedicated processing means in the mold-shift detection device 40, or may be embedded in the control unit of another device, such as the flaskless molding machine 1, the conveyance path 30 that conveys the upper and lower molds, or the pouring machine (not shown) that pours metal into the upper and lower molds.

The distance sensor is not necessarily the sensor that measures the distance by emitting light, and may be a sensor that measures the distance by emitting sound waves or radio waves.

### REFERENCE SIGNS LIST

1 . . . Flaskless molding machine, 2 . . . Upper mold, 3 . . . Lower mold, 4 . . . Surface plate bogie, 17 . . . Mold carry-in station, 18 . . . Mold-shift detection station, 19 . . . Parting surface, 20 . . . Rails, 22 . . . Frame, 30 . . . Conveyance path, 40 . . . Mold-shift detection device, 42 . . . Support frame, 44 . . . Up-and-down frame, 46 . . . Cylinder, 48 . . . Controller, 51 . . . First distance sensor, 52 . . . Second distance sensor, and 53 . . . Third distance sensor.

1. A mold-shift detection device for upper and lower molds molded and assembled with each other by a flaskless molding machine, comprising:
at least one distance sensor configured to measure a distance by irradiating side surfaces of the upper and lower molds with light;
a scanner configured to cause the at least one distance sensor to scan the side surfaces of the upper and lower molds; and
a controller configured to detect a mold-shift between the upper and lower molds, based on a measurement result in a scan range scanned by the scanner.

2. The mold-shift detection device for upper and lower molds according to claim 1, wherein the controller detects the mold-shift between the upper and lower molds, based on the measurement result associating a height position of the at least one distance sensor and the distance obtained by measurement.

3. The mold-shift detection device for upper and lower molds according to claim 2, wherein the controller outputs an approximate line of the distance in the scan range through linear regression analysis in a coordinate system with the height position and the distance being adopted as coordinate axes, and detects the mold-shift between the upper and lower molds, based on the approximate line.

4. The mold-shift detection device for upper and lower molds according to claim 3, wherein the controller detects the mold-shift between the upper and lower molds, based on a first intersection that is an intersection between the approximate line pertaining to the upper mold and a parting surface of the upper and lower molds, and a second intersection that is an intersection between the approximate line pertaining to the lower mold and the parting surface.

5. The mold-shift detection device for upper and lower molds according to claim 4, wherein the controller detects the mold-shift between the upper and lower molds, based on a difference between the first intersection and the second intersection.

6. The mold-shift detection device for upper and lower molds according to claim 5, wherein the controller stores a measurement result in the scan range, as a history, in a storage.

7. The mold-shift detection device for upper and lower molds according to claim 6, wherein the controller detects the mold-shift between the upper and lower molds, based on a comparison result between the difference and an immediately previous difference.

8. The mold-shift detection device for upper and lower molds according to claim 5, wherein the controller detects the mold-shift between the upper and lower molds, based on a comparison result between the difference and a predetermined threshold.

9. The mold-shift detection device for upper and lower molds according to claim 1, wherein the controller calculates respective central coordinates of the upper and lower molds and a skew angle between the upper and lower molds about a rotation axis that is in a vertical direction, based on a measurement result in the scan range, and detects the mold-shift between the upper and lower molds, based on the respective central coordinates of the upper and lower molds and the skew angle between the upper and lower molds.

10. The mold-shift detection device for upper and lower molds according to claim 9, wherein the controller stores the respective central coordinates of the upper and lower molds and the skew angle between the upper and lower molds, as a history, in a storage.

11. The mold-shift detection device for upper and lower molds according to claim 1, further comprising a notifier notifying abnormality when the mold-shift is detected by the controller.

12. The mold-shift detection device for upper and lower molds according to claim 1, wherein when the mold-shift is detected, the controller outputs an abnormal signal to another device.

13. The mold-shift detection device for upper and lower molds according to claim 1,
wherein the upper and lower molds include first side surfaces, and second side surfaces,
the at least one distance sensor includes a first distance sensor irradiating the first side surfaces with light, a second distance sensor irradiating the first side surfaces with light, and a third distance sensor irradiating the second side surfaces with light, and
the scanner causes the first distance sensor and the second distance sensor to scan the first side surfaces, and causes the third distance sensor to scan the second side surfaces.

14. A mold-shift detection method for upper and lower molds molded and assembled with each other by a flaskless molding machine, comprising:
causing at least one distance sensor to measure a distance by irradiating side surfaces of the upper and lower molds with light; and
detecting a mold-shift between the upper and lower molds, based on a measurement result in a scan range.

15. The mold-shift detection device for upper and lower molds according to claim 2, wherein the controller calculates respective central coordinates of the upper and lower molds and a skew angle between the upper and lower molds about a rotation axis that is in a vertical direction, based on a measurement result in the scan range, and detects the mold-shift between the upper and lower molds, based on the respective central coordinates of the upper and lower molds and the skew angle between the upper and lower molds.

16. The mold-shift detection device for upper and lower molds according to claim 3, wherein the controller calculates respective central coordinates of the upper and lower molds and a skew angle between the upper and lower molds about a rotation axis that is in a vertical direction, based on a measurement result in the scan range, and detects the mold-shift between the upper and lower molds, based on the respective central coordinates of the upper and lower molds and the skew angle between the upper and lower molds.

17. The mold-shift detection device for upper and lower molds according to claim 15, wherein the controller stores the respective central coordinates of the upper and lower molds and the skew angle between the upper and lower molds, as a history, in a storage.

18. The mold-shift detection device for upper and lower molds according to claim 2, further comprising a notifier notifying abnormality when the mold-shift is detected by the controller.

19. The mold-shift detection device for upper and lower molds according to claim 2, wherein when the mold-shift is detected, the controller outputs an abnormal signal to another device.

20. The mold-shift detection device for upper and lower molds according to claim 2,
wherein the upper and lower molds include first side surfaces, and second side surfaces,
the at least one distance sensor includes a first distance sensor irradiating the first side surfaces with light, a second distance sensor irradiating the first side surfaces with light, and a third distance sensor irradiating the second side surfaces with light, and
the scanner causes the first distance sensor and the second distance sensor to scan the first side surfaces, and causes the third distance sensor to scan the second side surfaces.
